(19) United States
(12) Patent Application Publication
(10) Pub. No.: US 2017/0176911 A1
(43) Pub. Date: Jun. 22, 2017

(54) IMAGE PROCESSING APPARATUS

(71) Applicants: KABUSHIKI KAISHA TOSHIBA, Tokyo (JP); TOSHIBA TEC KABUSHIKI KAISHA, Tokyo (JP)

(72) Inventors: Ken Iguchi, Numazu Shizuoka (JP); Isao Yahata, Izunokuni Shizuoka (JP)

(21) Appl. No.: 15/219,543

(22) Filed: Jul. 26, 2016

(30) Foreign Application Priority Data
Dec. 21, 2015 (JP) 2015-248412

(51) Int. Cl. G03G 15/00; B65H 7/00; B65H 1/28; B65H 1/04; B65H 1/26

(52) U.S. Cl. CPC G03G 15/6529; B65H 1/04; B65H 1/266; B65H 1/28; B65H 7/00; B65H 5/062

(57) ABSTRACT

An image processing apparatus comprises a first sheet supply mounted on a side wall and comprising a bottom extending upwards in the vertical direction at a predetermined angle from the side wall and a wall member vertically arranged on the bottom and forming a space with the bottom, and configured to house a sheet; a second sheet supply different from the first sheet supply and configured to store sheet flatly; a conveyance section configured to convey the sheet supplied from the first sheet supply or the second sheet supply to a processing section; and a controller to convey the sheet from the first sheet supply to the processing device if each of the first sheet supply and the second sheet supply houses the sheet.

### CROSS-REFERENCE TO RELATED APPLICATION

This application is based upon and claims the benefit of priority from Japanese Patent Application No. 2015-248412, filed Dec. 21, 2015, the entire contents of which are incorporated herein by reference.

### FIELD

Embodiments described herein relate generally to an image processing apparatus including a function of forming an image on a sheet and a function of decoloring the image formed on the sheet.

### BACKGROUND

In recent years, an image decoloring apparatus is known which sequentially conveys a sheet on the surface of which an image is formed with a coloring agent that can be decolored through heating at a predetermined temperature and carries out a decoloring process by pressuring and heating. Further, an image processing apparatus which includes a function of forming an image on a sheet and a function of decoloring the image formed on the sheet is also known.

In such an image processing apparatus, for example, if a user wants to decolor a sheet, the user houses the sheet in a cassette.

### DESCRIPTION OF THE DRAWINGS

FIG. 1 is a diagram illustrating the appearance of an image processing apparatus according to an embodiment;

FIG. 2 is a schematic view illustrating an example of the inner configuration of the image processing apparatus according to the embodiment;

FIG. 3 is a block diagram illustrating an example of the configuration of the image processing apparatus according to the embodiment;

FIG. 4A and FIG. 4B are diagrams illustrating a transition state of sheet feed according to a second embodiment;

FIG. 5A and FIG. 5B are diagrams illustrating the transition state of the sheet feed according to the second embodiment;

FIG. 6 is a flowchart illustrating an example of operations according to the second embodiment;

FIG. 7A and FIG. 7B are diagrams illustrating switching of conveyance paths corresponding to a size of a sheet according to a third embodiment;

FIG. 8 is a diagram illustrating the switching of the conveyance paths corresponding to the size of the sheet according to the third embodiment; and

FIG. 9 is a flowchart illustrating an example of operations according to the third embodiment.

### DETAILED DESCRIPTION

In accordance with an embodiment, an image processing apparatus comprises a first sheet supply mounted on a side wall of the image processing apparatus and comprising a bottom extending upwards in the vertical direction at a predetermined angle from the side wall for supporting an end of a sheet and a wall member vertically arranged on the bottom and forming a space with the bottom, and configured to house a sheet in the space through an opening formed on the upper side of the first sheet supply; a second sheet supply different from the first sheet supply and configured to store sheet flatly; a processing device configured to carry out an image processing on a conveyed sheet; a conveyance section configured to convey the sheet supplied from the first sheet supply or the second sheet supply to the processing section; and a controller configured to control the conveyance section to convey the sheet from the first sheet supply to the processing device if each of the first sheet supply and the second sheet supply houses the sheet.

The image processing apparatus of the embodiment is able to carry out both the decoloring process and an image forming process and can also form an image on a sheet to which the decoloring process is carried out as it is. While the image processing apparatus of the embodiment does not execute a printing process or a copy process, if there is a sheet that should be decolored, the image processing apparatus carries out the decoloring process on the sheet.

Further, the image processing apparatus of the embodiment can carry out both a printing operation with a decolorable color material and a printing operation with a non-decolorable color material. The decolorable color material is fixed on a sheet at a regulated fixing temperature and further decolored if heated at a decoloring temperature higher than the fixing temperature. The decolorable color material contains a color generation compound, a developer and a decoloring agent. As the color generation compound, for example, leuco dyes are exemplified. As the developer, for example, phenols are exemplified. As the decoloring agent, a substance which is blended with the color generation compound if heated and does not have affinity to the developer is exemplified. The decolorable color material develops the color through interaction of the color generation compound and the developer, and can be decolored as the interaction of the color generation compound and the developer is cut off through the heating at a temperature equal to or higher than the decoloring temperature.

In the embodiment, toner is exemplified as the color material; however, there may be a case in which the image forming processing is carried out by using ink. The “decoloring” according to the embodiment refers to a process of making an image formed with a color (containing not only chromatic colors but also achromatic colors such as white, black and the like) different from a base color of the sheet invisible visually. The “invisible visually” may be a form in which the image formed with the color different from the base color of the sheet is changed to a color identical or similar to the base color of the sheet in addition to a form in which the image formed with the color different from the base color of the sheet is colorless (that is, transparent).

The image processing apparatus of the embodiment includes a non-decolored sheet cassette for housing a non-decolored sheet serving as a used sheet, a decolored sheet cassette for housing a sheet to which the decoloring process is carried out through the heating and a normal cassette for housing anew sheet. Further, the image processing apparatus of the embodiment includes a pocket-like sheet feed section of which the upper part is opened on a side wall of the outside of a housing. A user throws a sheet to be processed into an opening section to complete the set to the sheet feed section. The pocket-like sheet feed section is called a side sheet feed section. The side sheet feed section vertically houses the sheet to be processed (non-decolored sheet in the embodiment).

In accordance with another embodiment, an image processing method involves determining whether a first sheet supply houses a first sheet, the first sheet supply being mounted on a side wall of the image processing apparatus and having a bottom for supporting an end of the first sheet and a wall vertically arranged on the bottom which forms a space with the bottom and the first sheet being housed in the space through an opening formed on the upper side of the first sheet supply; determining whether a second sheet supply stores a second sheet, the second sheet being stored flatly; conveying the first sheet in the first sheet supply or the second sheet in the second sheet supply to a processing device for image processing; carrying out image processing on the conveyed sheet; and if the first sheet supply houses the first sheet and the second sheet supply houses the second sheet, conveying the sheet from the first sheet supply to the processing device preferentially.

Hereinafter, each embodiment is described with reference to the accompanying drawings.

### First Embodiment

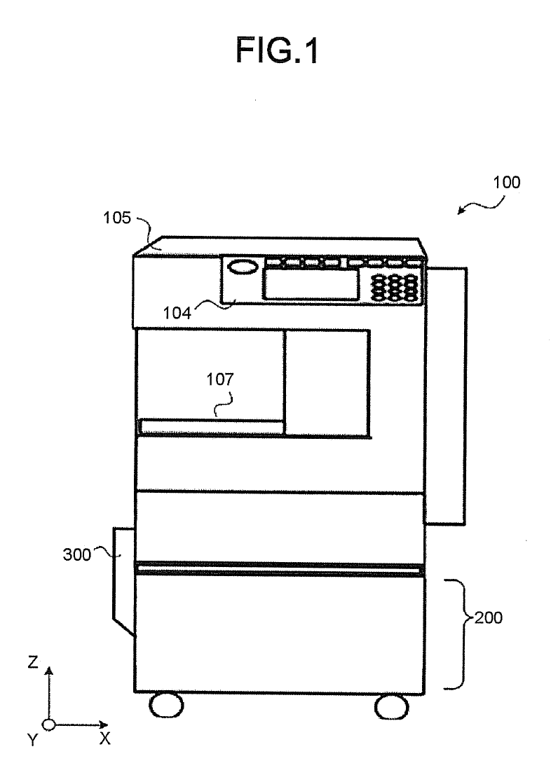

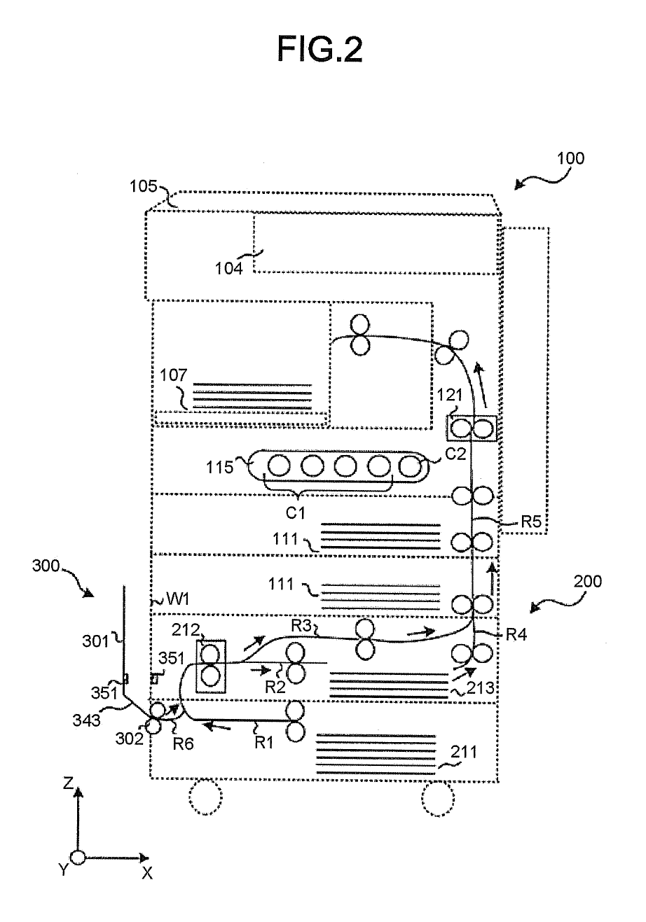

FIG. 1 illustrates an image processing apparatus according to the embodiment, and FIG. 2 illustrates a schematic view of the configuration of the image processing apparatus. X axis, Y axis and Z axis in FIG. 1 and FIG. 2 are common in each figure. Further, an arrow in FIG. 2 indicates a conveyance direction of a sheet.

An image processing apparatus 100 shown in FIG. 2 includes a normal cassette 111 for housing a new sheet or a sheet that is being used but at least one surface of which is at least unused. The image processing apparatus 100 includes an image forming section 115 for forming an image on a sheet and a discharge tray 107 for placing the sheet after the image formation. The image forming section 115 includes a cartridge C1 for housing the non-decolorable color material serving as a normal color material and a cartridge C2 for housing the decolorable color material to be decolored at the temperature equal to or higher than the decoloring temperature. The image processing apparatus 100 further includes a heating device 121 for heating and pressuring the sheet on which the image is formed to fix the image on the sheet.

The image processing apparatus 100 includes a conveyance path R5 for conveying the sheet to the normal cassette 111, the image forming section 115 and the discharge tray 107 in order. The image processing apparatus 100 includes an operation panel 104 for receiving the input of a parameter value such as the printing number of copies and an instruction of starting a processing from the user and displaying the state of progress of a job. The image processing apparatus 100 includes a reading section 105 for reading a document sheet. An image read by the reading section 105 is output to the image forming section 115, and the image forming section 115 forms the image on a sheet (copy processing).

The image processing apparatus 100 includes an image decoloring apparatus 200 in the lower portion of a main body section. The image decoloring apparatus 200 can be mounted in the main body section of the image processing apparatus 100 as an option, or provided as a simple substance.

The image decoloring apparatus 200 includes a non-decolored sheet cassette 211, a decoloring section 212 and a decolored sheet cassette 213. The non-decolored sheet cassette 211 houses a sheet having an image drawn with the color material to be decolored at the regulated or higher decoloring temperature. The decolored sheet cassette 213 houses the sheet on which the color material image is decolored by the decoloring section 212 through the heating to be reused later. The decoloring section 212 heats the sheet supplied from the non-decolored sheet cassette 211 at the temperature equal to or higher than the decoloring temperature using a heat source of the decoloring section 212. In this way, the decoloring section 212 decolors the color material on the sheet to decolor the drawn color material image. The decolored sheet cassette 213 loads and houses the sheet to which the decoloring process is carried out by the decoloring section 212.

The image decoloring apparatus 200 includes a conveyance path R1 for conveying the sheet from the non-decolored sheet cassette 211 to the decoloring section 212 and a conveyance path R2 for conveying the sheet from the decoloring section 212 to the decolored sheet cassette 213.

The image decoloring apparatus 200 further includes a conveyance path R4 one end of which is connected with the conveyance path R5 located in the main body section of the image processing apparatus 100 and the other end of which is connected with the decolored sheet cassette 213. If the image decoloring apparatus 200 is mounted in the main body section of the image processing apparatus 100 as the option, the conveyance path R4 is connected with the conveyance path R5 to be capable of supplying the sheet housed in the decolored sheet cassette 213 to the inside of the main body section. In this way, the image processing apparatus 100 can carry out the image formation even on the sheet housed in the decolored sheet cassette 213 with the image forming section 115 and discharge the sheet to the discharge tray 107 via the conveyance paths R4 and R5.

The image decoloring apparatus 200 includes a conveyance path R3 that branches from the conveyance path R2 and is connected with the conveyance path R5 at the downstream position of the decoloring section 212. Through the conveyance path R3, the sheet to which the decoloring process is carried out by the decoloring section 212 is immediately conveyed to the image forming section 115 without being housed in the decolored sheet cassette 213 to be subjected to the image forming processing. Through the configuration, in a case in which there is no sheet in the decolored sheet cassette 213, the image processing apparatus 100 supplies the sheet from the non-decolored sheet cassette 211 to the decoloring section 212 and then conveys the sheet passing the decoloring section 212 to the image forming section 115 as it is.

In this way, the image processing apparatus 100 is integrally mounted with the image decoloring apparatus 200 to be capable of executing a series of operations including decoloring the image with the decoloring section 212 and carrying out the image formation on the decolored sheet with the image forming section 115.

The image processing apparatus 100 of the embodiment can mount a side sheet feed section 300 on a side wall W1 thereof. The side sheet feed section 300 may be provided as an option (a simple substance) or integrally mounted with the image processing apparatus 100 or the image decoloring apparatus 200. The side sheet feed section 300 includes a contour section 301 and a sensor 351. A pickup section 302 may be included in the image decoloring apparatus 200 or the side sheet feed section 300. The contour section 301 is constituted by a bottom 343 and a side wall section vertically arranged on the bottom 343. The sheet is housed in a space formed by the side wall W1 of the image processing apparatus 100 and the side wall section of the contour section 301. The bottom 343 supports an end of the sheet. The contour section 301 is formed into a shape in which the length in the height direction (herein, Z axis direction) is at least longer than that in the horizontal direction (herein, X axis direction); however, it is not limited to this. The contour section 301 may be a shape in which the length in the Y axis direction is longer than that in the X axis direction. Further, for the relation between the length in the Y axis direction and the length in the Z axis direction, whether the sheet is housed in such a manner that the longitudinal direction of the sheet is the Z axis direction or the Y axis direction depends on the shape or area of the side wall W1. The contour section 301 may house the whole sheet or house the sheet in a state of exposing a part of the sheet if the size of the sheet is large.

If the side sheet feed section 300 is mounted, the bottom 343 of the contour section 301 is connected with a conveyance path R6. Through the configuration, the sheet housed in the side sheet feed section 300 is picked up by the pickup section 302 and supplied to the inside of the main body section through the conveyance path R6. The conveyance path R6 is merged with the conveyance path R1 at the upstream side of the decoloring section 212 as shown in FIG. 2. Thus, the sheet conveyed by the conveyance path R6 passes the conveyance path R1 and is subjected to the decoloring process by the decoloring section 212.

The contour section 301 serves as a contour for housing the sheet and serves as a container section for housing the sheet together with the side wall W1 of the image processing apparatus 100. The side sheet feed section 300 shown in FIG. 2 does not have the contour wall on the side wall W1 of the image processing apparatus 100; however, it may have the contour wall contacting with the side wall W1.

The upper part of the contour section 301 is opened, and the user vertically throws the sheet to be decolored into the side sheet feed section 300 through the opening section. The bottom 343 of the contour section 301 is inclined and extends upwards in the vertical direction at a predetermined angle from the side wall W1. The predetermined angle may be at least increased with the bottom 343 extending towards the outer side of the image processing apparatus 100 or decreased with the bottom 343 extending towards the side wall of the image processing apparatus 100. In the present embodiment, the angle of the bottom 343 with respect to the horizontal direction is about 30-50 degrees; however, it is not limited to this. By inclining the bottom 343 in this way, the sheet supported by the bottom 343 slides towards the side wall W1 of the image processing apparatus 100 due to gravity.

Further, the side wall section of the contour section 301 may be arranged in such a way as to be vertical (90 degrees) to the X-Y plane in the example shown in FIG. 2; however, the side wall section may be inclined to widen the opening area of the upper part so as to make the sheet easy to be thrown into the contour section 301. The inclination angle is allowed within a range from 45 degrees to 90 degrees with respect to the X-Y plane; however, it is not limited to this. In other words, a cross-section area of the container section of the side sheet feed section 300 in the X-Y plane increases as going up and decreases as going down. In a security relationship, the side wall section of the contour section 301 may be inclined in such a manner that the opening area of the upper part is narrowed (the cross-section area of the container section in the X-Y plane increases as going up and decreases as going down).

The sensor 351 detects whether or not there is a sheet housed in the side sheet feed section 300 and outputs a detection signal to a control section or controller described later. The sensor 351 is constituted as, for example, an infrared light-emitting device and a light receiving device. If there is no sheet between the light receiving device and the light emitting device, an infrared ray from the light emitting device arrives at the light receiving device as it is; however, if the sheet is housed, the infrared ray from the light emitting device is shielded and does not arrive at the light receiving device. In the present embodiment, in a case in which the light receiving device receives the infrared ray, it is determined that the sheet is not housed, but in a case in which the light receiving device does not receive the infrared ray, it is determined that the sheet is housed.

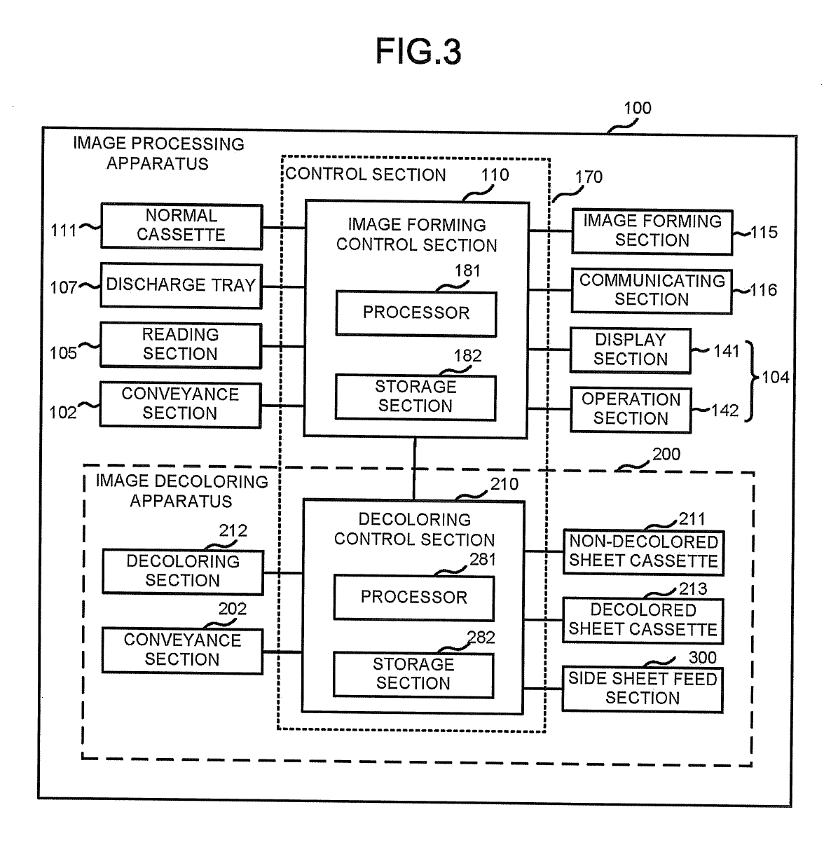

FIG. 3 illustrates a block diagram of the image processing apparatus 100 according to the embodiment. The image processing apparatus 100 includes an image forming control section 110 (controller) at least containing a processor 181 and a storage section 182. The processor 181 is an arithmetic processing apparatus such as a CPU (Central Processing Unit). The processor 181 executes programs stored in the storage section 182 to realize various functions. The storage section 182 includes a main storage device for storing data in a volatile manner and directly carrying out input and output of the data from and to the processor 181. The storage section 182 further includes a ROM or an auxiliary storage device for storing data and programs in a non-volatile manner. Through the configuration, the image forming control section 110 collectively controls the main body unit of the image processing apparatus 100.

The image processing apparatus 100 includes a communicating section 116. The communicating section 116 receives print data from a personal computer and replies a telegram relating to a processing result and a status to the personal computer serving as a sending source according to instructions of the image forming control section 110.

The normal cassette 111, the discharge tray 107 and the reading section 105 shown in FIG. 3 are described as stated above. The operation panel 104 includes a display section 141 serving as a flat-type liquid crystal monitor and an operation section 142 constituted by physical buttons and a touch panel laminated on the display section 141. The conveyance section 102 which includes the conveyance path R5 conveys the sheet to each unit according to the instructions of the image forming control section 110.

The image decoloring apparatus 200 includes a decoloring control section 210 (controller). The decoloring control section 210 collectively controls each unit in the image decoloring apparatus 200 and includes a processor 281 and a storage section 282. The processor 281 controls the inner unit of the image decoloring apparatus 200 according to data and program codes stored in the storage section 282. A part or all of the decoloring control section 210 may be installed in a circuit such as an ASIC (application specific integrated circuit). Furthermore, the functions of the decoloring control section 210 may be carried out by the image forming control section 110 of the image processing apparatus 100.

The non-decolored sheet cassette 211, the decolored sheet cassette 213, the decoloring section 212 and the side sheet feed section 300 in FIG. 3 are identical to the above. A conveyance section 202 which includes the conveyance paths R1, R2, R3, R4 and R6 conveys the sheet to each unit according to instructions of the decoloring control section 210.

A configuration containing the image forming control section 110 and the decoloring control section 210 is set to a control section 170 (controller). In other words, the control section 170 collectively controls all the units in the image processing apparatus 100 containing the image decoloring apparatus 200 and the side sheet feed section 300.

In the image decoloring apparatus 200, in a decoloring operation, if the non-decolored sheet cassette 211 is switched from a closed state to an opened state, it is possible that sheet jam occurs or the sheet is destroyed due to shearing generated between the cassette and the main body. Thus, in the decoloring operation, it is forbidden in principle that the non-decolored sheet cassette 211 is kept in the opened state. The forgoing situation is the same as that even in other cassette sections, and it is forbidden in principle that the cassette sections are kept in the opened state in the decoloring operation. On the other hand, by arranging the side sheet feed section 300, even in the decoloring operation, the user is possible to throw and set a sheet to be processed into the side sheet feed section 300.

The side sheet feed section 300 may be arranged in such a way as to be long in the height direction (Z axis direction). In this way, a setting area of the image processing apparatus 100 can be small.

By arranging the side sheet feed section 300, the user only need to carryout an operation of throwing a sheet to be processed into the side sheet feed section 300. In other words, the user does not need to do complex operations of switching the cassette to the opened state to set the sheet and closing the cassette at the time of setting the sheet to be processed in the image processing apparatus 100.

Further, by adopting a non-transparent contour section for vertically housing a sheet in the side sheet feed section, a third party can easily recognize the sheet visually.

### Second Embodiment

If a sheet is placed in a vertical state for a long time, there is a problem that the sheet is deformed. Further, although the third party cannot easily recognize the sheet visually if the sheet is housed in the side sheet feed section 300 in the vertical state, keeping the sheet as it is cannot resolve a security problem.

In the second embodiment, if both the non-decolored sheet cassette 211 and the side sheet feed section 300 house the sheets, the image decoloring apparatus 200 processes the sheet in the side sheet feed section 300 preferentially. By preferentially processing the sheet in the side sheet feed section 300, a time of leaving the sheet in the side sheet feed section 300 is decreased, and thus the deformation of the sheet can be suppressed to an extent and the visual recognition opportunity from the third party can be decreased. The configuration except for the following configuration of the second embodiment is identical to that of the first embodiment.

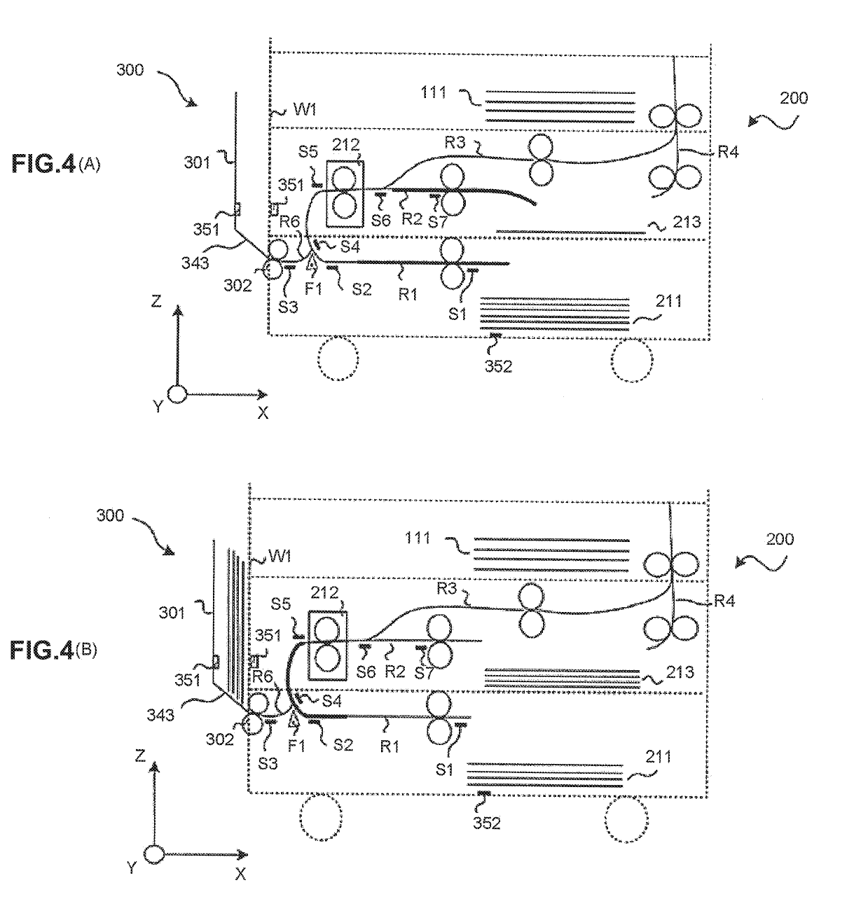

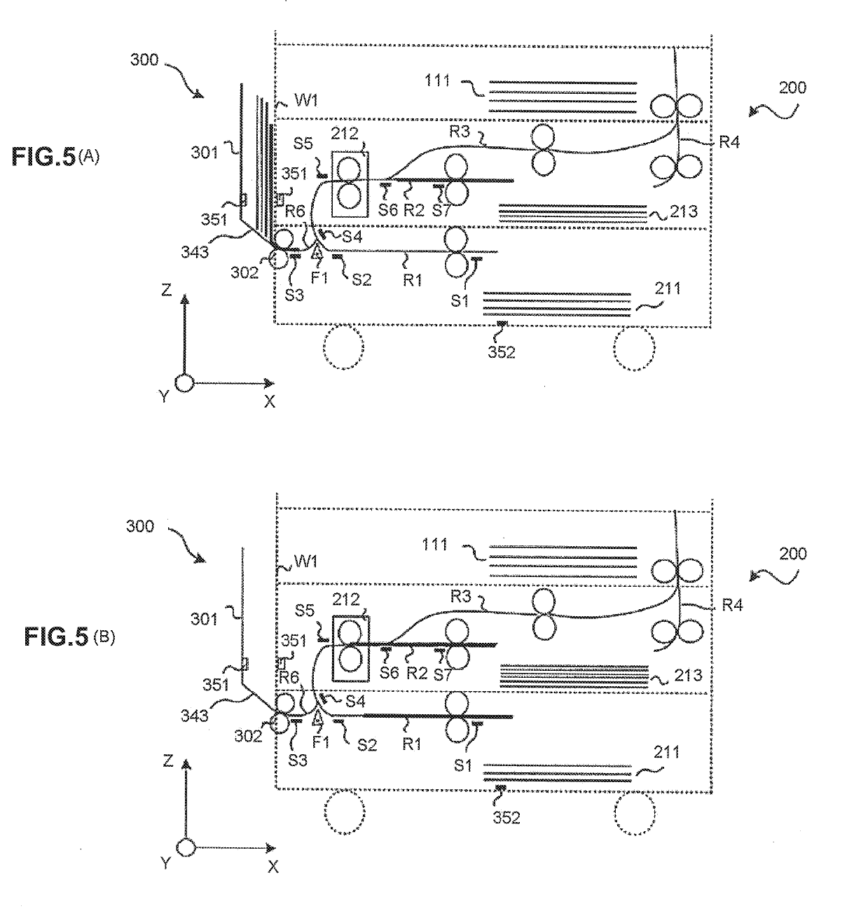

FIG. 4 and FIG. 5 illustrate sheet feeding and an arrangement of sensors included in each conveyance path according to the second embodiment. In the each following figure, a thick line on the conveyance path indicates a sheet. Furthermore, the control section 170 controls a flapper F1 located at a meeting point of the conveyance paths R1 and R6 to switch the conveyance paths R1 and R6.

Sensors S1˜S7 for detecting presence or absence of the sheet are arranged in the conveyance paths. Detection signals from the sensors S1˜S7 are output to the control section 170. The sensors S1˜S7 may be diverted to sensors for detecting the sheet jam.

The sensors S1, sensor S2, S4 and S5 are arranged in the conveyance path R1 in order from the upstream side. The sensor S1 is located nearby the pickup section of the non-decolored sheet cassette 211. The sensor S2 is arranged at a bending point. The sensor S4 is located nearby the meeting point of the conveyance path R1 and the conveyance path R6. The sensor S5 is arranged at a bending point at the upstream side around the decoloring section 212.

The sensors S6 and the sensor S7 are arranged in the conveyance path R2. The sensor S6 is arranged at the upstream side of a branching point of the conveyance path R2 and the conveyance path R3 and at the downstream side of the decoloring section 212. The sensor S7 is arranged nearby a roller (terminal roller of the conveyance path R2) for supplying the sheet to the decolored sheet cassette 213.

The sensors S3 and S4 are arranged in the conveyance path R6 from the upstream side. The sensor S3 is arranged nearby the pickup section 302, and the sensor S4 is arranged before or nearby the merging point of the conveyance path R1 and the conveyance path R6 as stated above.

In the second embodiment, the image decoloring apparatus 200 includes a sensor 352 for detecting whether or not there is a sheet in the non-decolored sheet cassette 211. The sensor 352 is, for example, a physical switch which is pressed according to the weight of the sheets to switch turning on/off. A detection signal from the sensor 352 is output to the control section 170.

FIG. 4(A) illustrates a conveyance state when there is no sheet in the side sheet feed section 300. As there is no sheet in the side sheet feed section 300, in a case in which there is a sheet in the non-decolored sheet cassette 211, the sheet is fed from the non-decolored sheet cassette 211. The sheet feed may be carried out as the control section 170 determines the timing when the image forming is not carried out or according to the instruction from the user via the operation panel 104. In a case in which there is no sheet in the side sheet feed section 300, in the present embodiment, the sheets stacked in the non-decolored sheet cassette 211 are conveyed in order and the decoloring process is carried out on the sheets. The presence or absence of the sheets in the side sheet feed section 300 is determined according to an output signal from the sensor 351, and the presence or absence of the sheets in the non-decolored sheet cassette 211 is determined according to an output signal from the sensor 352.

FIG. 4(B) illustrates a condition in which the sheet is newly housed in the side sheet feed section 300 during a process of the sheet conveyed from the non-decolored sheet cassette 211. The process refers to a conveyance processing or/and the decoloring process. In the present embodiment, if there is a sheet which has already been fed from the non-decolored sheet cassette 211 and is under the process, the process is continued on the sheet. Whether there is a sheet that is being processed is determined according to the detection signals from the sensors S1, S2, S4, S5, S6 and S7.

In the present embodiment, if the sheet is housed in the side sheet feed section 300, the succeeding sheet feed from the non-decolored sheet cassette 211 is interrupted, and a next sheet is fed from the side sheet feed section 300. FIG. 5(A) illustrates a state where the paper feed from the non-decolored sheet cassette 211 is stopped and the sheet is fed from the side sheet feed section 300. Then, the sheets are fed in order from the side sheet feed section 300 and the decoloring process is carried out on the sheets until there is no sheet in the side sheet feed section 300. If there is no sheet in the side sheet feed section 300, next, the sheet feed from the non-decolored sheet cassette 211 is restarted (refer to FIG. 5(B)).

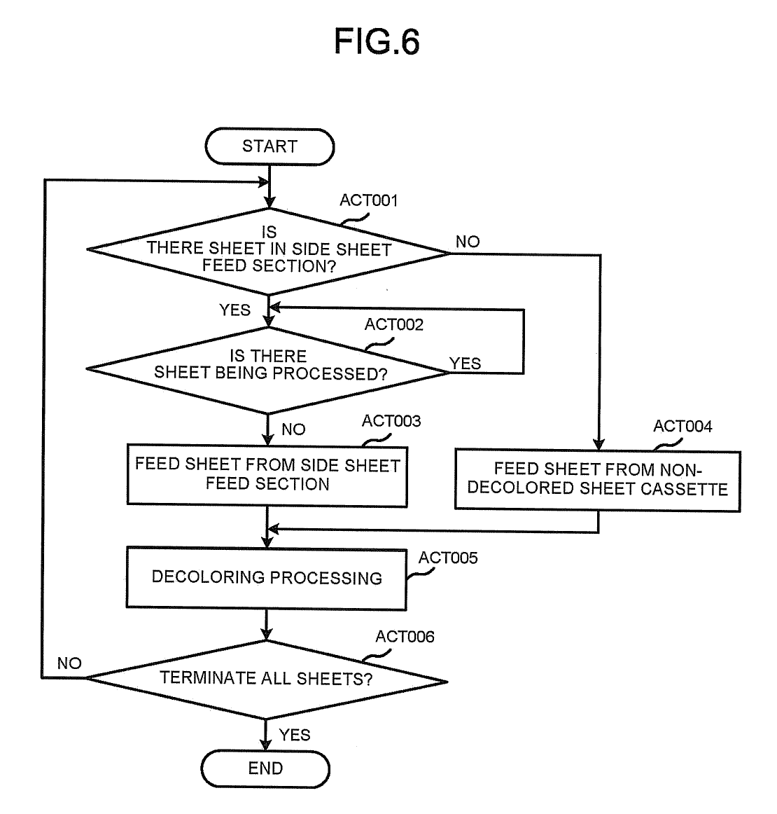

FIG. 6 illustrates a flowchart of operations of the control section 170 according to the second embodiment. In other words, the processor of the image forming control section 110 or the decoloring control section 210 executes the program stored in the storage section to control the operations shown in FIG. 6.

The control section 170 determines whether or not there is a sheet in the side sheet feed section 300 according to the detection signal of the sensor 351 (ACT 001). If there is no sheet in the side sheet feed section 300 (No in ACT 001), the control section 170 controls the non-decolored sheet cassette 211 to feed the sheet (ACT 004), and controls each conveyance path and the decoloring section 212 to carry out the decoloring process (ACT 005). On the other hand, if there is the sheet in the side sheet feed section 300 (Yes in ACT 001), the control section 170 determines whether there is a sheet which is under the processing in the conveyance path (ACT 002) based on the detection signals of the sensors S1, S2, S4, S5, S6 and S7. If the sheet in the conveyance path is detected, the controller 170 controls to complete the process to the conveyed sheet (Yes in ACT 002). At this time if the sheet is conveyed from the non-decolored sheet cassette 221 and the sensor 352 detects the sheet, the controller 170 control the non-decolored sheet cassette 221 to stop feeding sheet. The sheet that is being processed refers to a sheet that is being conveyed or/and a sheet in the decoloring process, identical to that stated above. If there is no sheet in the conveyance path or the process to all the sheets fed from the non-decolored sheet cassette 211 are completed (No in ACT 002), the control section 170 controls the side sheet feed section 300 to feed a sheet (ACT 003), and carries out the decoloring process on the sheet (ACT 005).

The control section 170 repeatedly executes the processing in ACT 001˜ACT 005 (loop of No in ACT 006) until there is no sheet in the side sheet feed section 300 and the non-decolored sheet cassette 211.

In other words, the flowchart in FIG. 6 illustrates the following operations. In a state where the sheet is housed in the non-decolored sheet cassette 211, if the sheet is newly housed in the side sheet feed section 300 (Yes in ACT 001), the control section 170 according to the second embodiment controls the conveyance section 202 to preferentially convey the sheet housed in the side sheet feed section 300 to the decoloring section 212 (ACT 003).

If the sheet from the non-decolored sheet cassette 211 is being processed, the processing on the sheet is continued (ACT 002), the control section 170 controls to feed the sheet from the side sheet feed section 300 (ACT 003). If there is no sheet in the side sheet feed section 300 (No in ACT 001), the sheet feed from the non-decolored sheet cassette 211 is restarted (ACT 004).

As shown in FIG. 4(A), FIG. 5(A) and FIG. 5(B), in the present embodiment, while a sheet is being processed, a next sheet is invaded to the conveyance path to an extent and stands by as needed; however, the form is not limited to this. After a processing on the sheet to which the processing is carried out is completed, the next sheet may be fed.

According to the second embodiment, by preferentially processing the sheet in the side sheet feed section 300, it is suppressed that the sheet is placed in the side sheet feed section 300, and the deformation of the sheet and the visual recognition from the third party can be suppressed.

### Third Embodiment

There is a case in which sheets with various sizes are thrown into the side sheet feed section 300. If a sheet with a larger size than a regulated size at which the sheets can be housed in the decolored sheet cassette 213, the decolored sheet cassette 213 cannot house the sheet. On the other hand, the decolored sheet cassette 213 can house a sheet with a smaller size than the regulated size. However, if the sheet with the smaller size than the regulated size is housed, at the time of the image forming processing in a post-processing, when the sheet is fed from the decolored sheet cassette 213, there is a high possibility that the pickup operation is failed and the sheet jam occurs. In the third embodiment, it is described that the conveyance paths are switched in response to the size of the sheet and a message is displayed and notified to the user. The configuration except the following configuration of the third embodiment is identical to those of the first embodiment and the second embodiment.

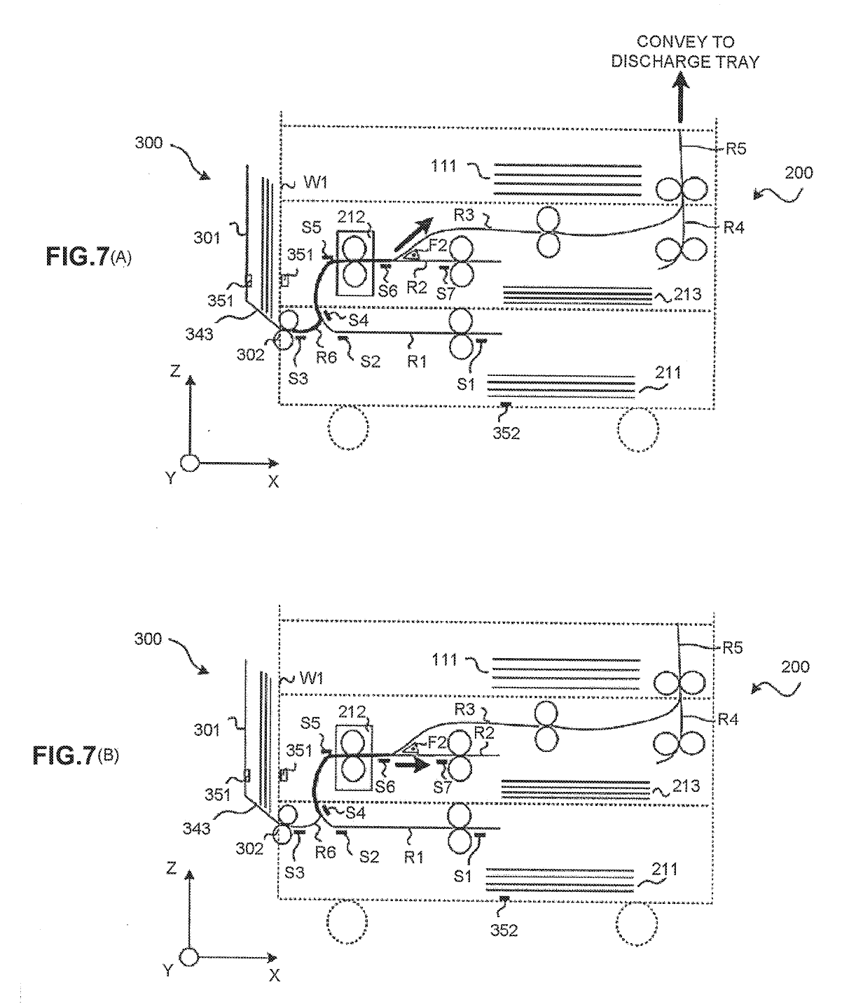

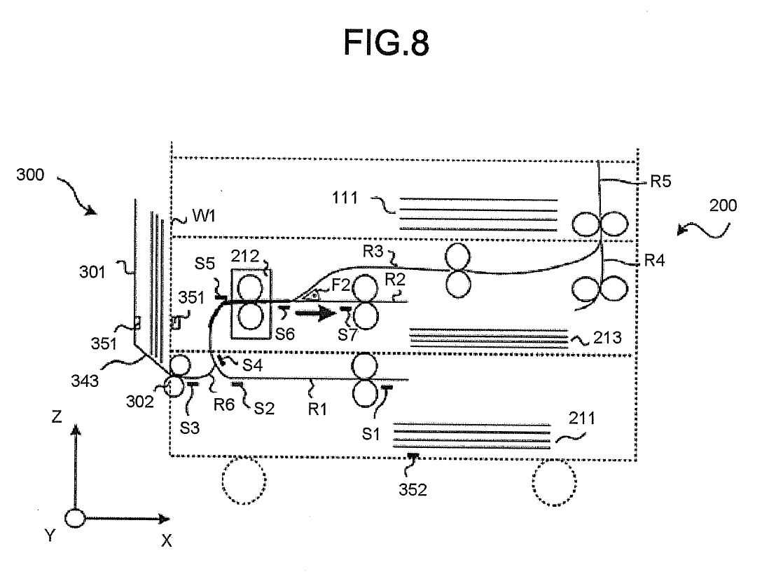

The third embodiment is described with reference to FIG. 7 and FIG. 8. In the third embodiment, the sensors S3, S4 and S6 described in the second embodiment are used to detect the size of the sheet (specifically, the length in the conveyance path direction). In the third embodiment, when the front end of the sheet is detected by the sensor S6, the size of the sheet is determined according to whether the sheet is detected by the sensor S3 or the sensor S4. In the third embodiment, it is regarded that the length of the conveyance path from the sensor S6 to the sensor S4 is coincident with a predetermined size for housing in the decolored sheet cassette 213 (the length of the decolored sheet cassette 213 in the X axis direction). The predetermined size for housing in the decolored sheet cassette 213 is set to, for example, A4 size which is called the regulated size as needed.

As shown in FIG. 7 (A), when the sheet arrives at the sensor S6 and the front end of the sheet is detected by the sensor S6, if the sheet is also detected by the sensor S3, it can be regarded that the size of the sheet is larger than the predetermined size. In this way, if the decoloring process is carried out on the sheet with the size larger than the predetermined size, as the sheet cannot be housed in the decolored sheet cassette 213, the control section 170 controls the flapper F2 to convey the sheet to the conveyance path R3. The sheet conveyed to the conveyance path R3 is conveyed to the discharge tray 107 via the conveyance path R5 and discharged to the outside of the apparatus.

Further, as shown in FIG. 7 (B), when the front end of the sheet is detected by the sensor S6, if the sheet is detected by the sensor S4 but not the sensor S3, the control section 170 determines that the size of the sheet is the predetermined size. In a case in which the size of the sheet is the predetermined size, the control section 170 controls the flapper F2 to convey the sheet to the conveyance path R2. The sheet conveyed to the conveyance path R2 is housed in the decolored sheet cassette 213 as it is.

As shown in FIG. 8, when the front end of the sheet is detected by the sensor S6, if the front end of the sheet is not detected by the sensor S4, the control section 170 determines that the size of the sheet is smaller than the predetermined size. In a case in which the size of the sheet is smaller than the predetermined size, the control section 170 controls the flapper F2 to convey the sheet to the conveyance path R2. The sheet conveyed to the conveyance path R2 is housed in the decolored sheet cassette 213 as it is. Then, the control section 170 notifies the user that the sheet with the size except the regulated size is housed. Otherwise, in a case in which the size of the sheet is smaller than the predetermined size, under the control of the control section 170, the sheet may be conveyed to the discharge tray 107 via the conveyance path R3 or the conveyance path R5 and discharged to the outside of the apparatus.

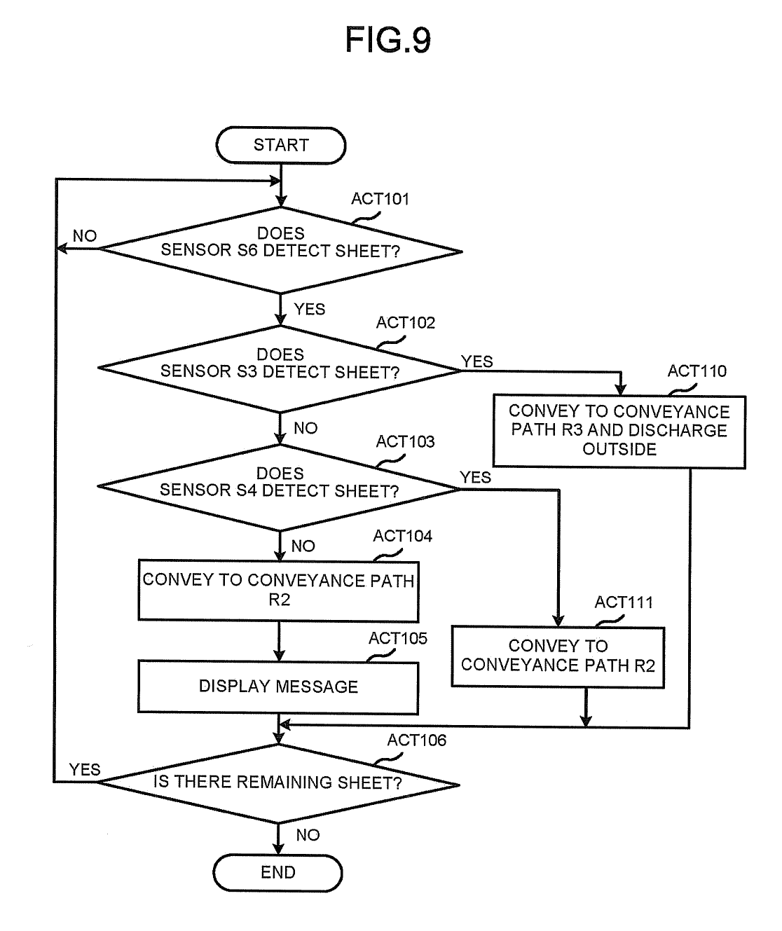

FIG. 9 illustrates flowchart operations of the control section 170 to switch the conveyance path direction according to the third embodiment.

The control section 170 determines whether or not the front end of the sheet is detected by the sensor S6 located at the upstream side of the branching point of the conveyance path R2 and the conveyance path R3 (ACT 101). The control section 170 stands by until the sensor S6 detects the sheet (loop of No in ACT 101).

If the sensor S6 detects the sheet (Yes in ACT 101), the control section 170 determines whether or not the sensor S3 detects the sheet (ACT 102). If the sensor S3 detects the sheet (Yes in ACT 102), as the sheet is a sheet with the size larger than the regulated size, the control section 170 controls the flapper F2 to guide the sheet to the conveyance path R3 (ACT 110). The control section 170 controls the conveyance paths R3 and R5 to convey the sheet to the discharge tray 107 (ACT 110). Then, the processing proceeds to the processing in ACT 106.

If the sensor S3 does not detect the sheet (No in ACT 102) and the sensor S4 detects the sheet (Yes in ACT 103), the size of the sheet is the regulated size, and thus the control section 170 controls the flapper F2 to guide the sheet to the conveyance path R2 to enable the sheet to be housed in the decolored sheet cassette 213 (ACT 111). Then, the processing proceeds to the processing in ACT 106.

If the sensor S4 does not detect the sheet either (No in ACT 103), the control section 170 determines that the size of the sheet is smaller than the regulated size and controls the flapper F2 to guide the sheet to the conveyance path R2 (ACT 104). Then, the sheet is housed in the decolored sheet cassette 213. The control section 170 controls the operation panel 104 to display the message (ACT 105), that the sheet with the size except the regulated size is housed in the decolored sheet cassette 213 is notified to the user. Further, the processing may be interrupted until the sheet is removed from the decolored sheet cassette 213. In this way, the control section 170 stands by until a predetermined restart operation is carried out through the operation panel 104.

The foregoing processing is carried out until there is no sheet in the side sheet feed section 300 (Yes in ACT 106). In the processing in ACT 106, the control section 170 determines the presence or absence of the sheet in the side sheet feed section 300 according to the detection signal of the sensor 351. If there is no sheet (No in ACT 106), the processing is ended.

In the third embodiment, the sensors S3, S4 and S6 are used to determine the size of the sheet that is being processed in this way; however, in a case in which the sheet is determined by any one of the sensors, whether to switch the flapper F2 and display the message depends on the arrangement state of each sensor and the length of the conveyance path. Further, in the foregoing embodiment, on the basis of the sensor S6, the flapper F2 is controlled or the message is displayed in response to a relative position on the conveyance path from the sensor S6, and which one of the sensors is set to a reference depends on an operation speed from the detection of sheet to the switching of the flapper F2. For example, when the sheet is detected by the sensor S6, it is also considered that the switching of the flapper F2 is already missed. In this way, the sensor at the upstream side is set to the reference with respect to the sensor S6. Furthermore, the arrangement position of the sensor and the number of the sensors are suitably designed.

In the foregoing embodiment, for the sheet fed from the side sheet feed section 300, the detection of the sheet or the switching of the conveyance paths and the display of the message are mentioned; however, they are also applicable to the sheet fed from another cassette (for example, the non-decolored sheet cassette 211).

The forms of the first to third embodiments may be combined. In the description of the foregoing embodiments, it is described that the “decoloring process” refers to erasing the color of the image; however, it may refer to erasing the image. In other words, the image decoloring apparatus recorded in the present embodiment is not limited to the apparatus that erases the color of the image through the heating. For example, the image erasing apparatus may be an apparatus that erases the color of the image on a sheet through irradiation of light or an apparatus that erases the image formed on a special sheet. Otherwise, the image erasing apparatus may be an apparatus that removes (erases) the image on the sheet. The image erasing apparatus may make the image on the sheet invisible to be capable of reusing the sheet.

Further, the “image processing” described in the each forgoing embodiment includes a processing of forming the image or/and a processing of erasing the image.

As stated above in detail, according to the embodiment, the sheet can be set in the supply section in a workmanlike manner. According to the second embodiment, the visual recognition from the third party can be suppressed, and the deformation of the sheet can be suppressed. Further, according to the third embodiment, the paper jam depending on the size of the sheet can be suppressed.

While certain embodiments have been described, these embodiments have been presented by way of example only, and are not intended to limit the scope of the invention. Indeed, the novel embodiments described herein may be embodied in a variety of other forms; furthermore, various omissions, substitutions and changes in the form of the embodiments described herein may be made without departing from the spirit of the invention. The accompanying claims and their equivalents are intended to cover such forms or modifications as would fall within the scope and spirit of the invention.

What is claimed is:

1. An image processing apparatus, comprising:
a first sheet supply mounted on a side wall of the image processing apparatus and comprising a bottom extending upwards in the vertical direction at a predetermined angle from the side wall for supporting an end of a sheet and a wall member vertically arranged on the bottom and forming a space with the bottom, and configured to house a sheet in the space through an opening formed on the upper side of the first sheet supply;
a second sheet supply different from the first sheet supply and configured to store sheet flatly;
a processing device configured to carry out an image processing on a conveyed sheet;
a conveyance section configured to convey the sheet supplied from the first sheet supply or the second sheet supply to the processing section; and
a controller configured to control the conveyance section to convey the sheet from the first sheet supply to the processing device if each of the first sheet supply and the second sheet supply houses the sheet.

2. The image processing apparatus according to claim 1, wherein the processing device is configured to decolor an image on the conveyed sheet as the image processing.

3. The image processing apparatus according to claim 1, wherein the controller is configured to
control the first sheet supply to feed the sheet to the conveyance section preferentially if each of the first sheet supply and the second sheet supply houses the sheet, and
control the second sheet supply to feed the sheet to the conveyance section if the first sheet supply houses no sheet.

4. The image processing apparatus according to claim 3, wherein
the sheet housed in the first sheet supply is a first sheet and the sheet housed in the second sheet supply is a second sheet; and
if the first sheet supply receives the first sheet through the opening while the second sheet supplied from the second sheet supply is being processed, the controller is configured to
control the second sheet supply to interrupt to supply the following sheet, and
control the first sheet supply and the conveyance section to convey the first sheet housed in the first sheet supply to the processing section.

5. The image processing apparatus according to claim 4, wherein
the controller is configured to control the second sheet supply to resume supplying the second sheet after all of the sheets housed in the first sheet supply is supplied.

6. The image processing apparatus according to claim 2, further comprising:
a housing located at the downstream side in a sheet conveyance direction with respect to the processing device and configured to house the sheet having a predetermined size, the image of the sheet being decolored by the processing device;
a discharge tray configured to stack the sheet discharged from the inside of image processing apparatus;
wherein
the conveyance section has a first conveyance path which conveys the sheet from the processing device to the housing and a second conveyance path which conveys the sheet from the processing device to the discharge tray without passing through the housing, and
if a size of a sheet of which the image is decolored by the processing device is different from the predetermined size, the controller is configured to control the conveyance section to convey the decolored sheet to the discharge tray through the second conveyance path.

7. The image processing apparatus according to claim 6, wherein the controller is configured to
control the conveyance section to convey the decolored sheet to the discharge tray through the second conveyance path if the size of the sheet is larger than the predetermined, and
control the conveyance section to convey the decolored sheet to the housing through the first conveyance path if the size of the sheet is equal to or smaller than the predetermined.

8. The image processing apparatus according to claim 1, further comprising
a display;
wherein the controller is configured to display to display that the decolored sheet which is smaller than the predetermined size is conveyed to the housing.

9. An image processing method of an image processing apparatus, comprising:
determining whether a first sheet supply houses a first sheet, the first sheet supply being mounted on a side wall of the image processing apparatus and having a bottom for supporting an end of the first sheet and a wall vertically arranged on the bottom which forms a space with the bottom and the first sheet being housed in the space through an opening formed on the upper side of the first sheet supply;
determining whether a second sheet supply stores a second sheet, the second sheet being stored flatly;
conveying the first sheet in the first sheet supply or the second sheet in the second sheet supply to a processing device for image processing; carrying out image processing on the conveyed sheet; and
if the first sheet supply houses the first sheet and the second sheet supply houses the second sheet, conveying the sheet from the first sheet supply to the processing device preferentially.

10. The image processing method according to claim 9, wherein the processing device is configured to decolor an image on the conveyed sheet as the image processing.

11. The image processing apparatus according to claim 9, wherein
conveying the first sheet from the first sheet supply if each of the first sheet supply and the second sheet supply houses the sheet, and
conveying the second sheet from the second sheet supply if the first sheet supply houses no sheet.

12. The image processing method according to claim 9, further comprising:
if the first sheet is housed in the first sheet supply while the second sheet from the second sheet supply is under the image processing, interrupting conveying the following sheet from the second sheet supply; and
conveying the first sheet housed in the first sheet supply for image processing.

13. The image processing method according to claim 12, wherein
resuming conveying the second after all of the first sheets housed in the first sheet supply is supplied.

14. The image processing method according to claim 7, further comprising
if a size of a sheet being image processed is a predetermined size, conveying the sheet to a housing located at the downstream side in a sheet conveyance direction to the processing device,
if the size of the sheet being image processed is different from the predetermined size,
discharging the sheet to outside of the image processing apparatus by conveying the sheet without passing through the housing.

15. The image processing method according to claim 14, wherein the image of the sheet image processed by the processing device is decolored,
conveying the decolored sheet to outside if the size of the sheet is larger than the predetermined, and
conveying the decolored sheet to the housing if the size of the sheet is equal to or smaller than the predetermined.

16. The image processing method according to claim 15, further comprising
notifying that the decolored sheet which is smaller than the predetermined size is conveyed to the housing.
